(19) United States
(12) Patent Application Publication
(10) Pub. No.: US 2025/0362878 A1
(43) Pub. Date: Nov. 27, 2025

(54) CIRCUIT SELECTIVELY OPERABLE AS RANDOM NUMBER GENERATOR OR PHYSICAL UNCLONABLE FUNCTION (PUF) DEVICE AND METHOD OF OPERATING THE SAME

(71) Applicant: KOREA UNIVERSITY RESEARCH AND BUSINESS FOUNDATION, Seoul (KR)

(72) Inventors: Chulwoo Kim, Seoul (KR); Woojin Lee, Seoul (KR); Yohan Choi, Seoul (KR); Jinwoo Jeon, Seoul (KR); Hyunjin Kim, Seoul (KR); Hyundo Jung, Seoul (KR)

(73) Assignee: KOREA UNIVERSITY RESEARCH AND BUSINESS FOUNDATION, Seoul (KR)

(21) Appl. No.: 18/888,292

(22) Filed: Sep. 18, 2024

(30) Foreign Application Priority Data
May 27, 2024 (KR) 10-2024-0068842
Jul. 5, 2024 (KR) 10-2024-0089119

(51) Int. Cl. G06F 7/58

(52) U.S. Cl. CPC G06F 7/588

(57) ABSTRACT

A circuit selectively operable as a random number generator or a physical unclonable function (PUF) device and a method of operating the same are provided. The circuit includes a first inverter, a second inverter, a first switch connected between an input node of the first inverter and an output node of the first inverter, a second switch connected between an input node of the second inverter and an output node of the second inverter, a first capacitor connected between the input node of the first inverter and the output node of the second inverter, a second capacitor connected between the output node of the first inverter and the input node of the second inverter, a third switch connected in parallel with the first capacitor, and a fourth switch connected in parallel with the second capacitor.

### CROSS-REFERENCE TO RELATED APPLICATION

This application is based on and claims priority under 35 U.S.C. § 119 to Korean Patent Application No. 10-2024-0068842, filed on May 27, 2024, and Korean Patent Application No. 10-2024-0089119, filed on Jul. 5, 2024, in the Korean Intellectual Property Office, the disclosures of which are incorporated by reference herein in their entireties.

### BACKGROUND

### 1. Field

The disclosure relates to a random number generator or a physical unclonable function (PUF) device.

### [Acknowledgements]

This research was supported by the Samsung Future Technology Promotion Project (Project No.: SRFC-IT2101-03).

### 2. Description of the Related Art

The ideal goal of random number generators is to generate completely random numbers. For example, when a random number generator generates 0 or 1 with a probability of 50%, the random number generator may be a true random number generator (TRNG), and the generated random number may be a true random number. Completely random numbers are unpredictable and play a key role in fields such as cryptography and security.

Physical unclonable function (PUF) devices generate unique random numbers based on unique randomness generated during a manufacturing process. PUF devices are likened to digital fingerprints and used as unique identifiers of electronic devices.

While random number generators generate random numbers with respect to the same input, PUF devices need to generate consistent and unique random numbers with respect to the same input. Random number generators and PUF devices have different roles and technical characteristics and also are implemented as different circuits.

### SUMMARY

The disclosure provides a circuit selectively operable as a random number generator or a physical unclonable function (PUF) device and a method of operating the same.

Additional aspects will be set forth in part in the description which follows and, in part, will be apparent from the description, or may be learned by practice of the presented embodiments of the disclosure.

According to an aspect of the disclosure, a circuit selectively operable as a random number generator or a physical unclonable function (PUF) device is provided.

The circuit includes a first inverter, a second inverter, a first switch connected between an input node of the first inverter and an output node of the first inverter, a second switch connected between an input node of the second inverter and an output node of the second inverter, a first capacitor connected between the input node of the first inverter and the output node of the second inverter, a second capacitor connected between the output node of the first inverter and the input node of the second inverter, a third switch connected in parallel with the first capacitor, and a fourth switch connected in parallel with the second capacitor.

In an embodiment, the circuit may be operable as the random number generator when the third switch and the fourth switch are opened.

In an embodiment, the circuit may be operable as the PUF device when the third switch and the fourth switch are closed.

In an embodiment, the third switch and the fourth switch may be simultaneously opened or closed.

In an embodiment, the circuit may further include a first perturbation circuit configured to apply a first perturbation voltage to the input node of the first inverter, and a second perturbation circuit configured to apply a second perturbation voltage to the input node of the second inverter.

In an embodiment, the first inverter and the second inverter may be complementary metal oxide semiconductor (CMOS) inverters, the first perturbation voltage may be determined based on a product between a length and a width of the first inverter, and the second perturbation voltage may be determined based on a product between a length and a width of the second inverter.

In an embodiment, the first perturbation voltage may be determined based on capacitance of the first inverter, and the second perturbation voltage may be determined based on capacitance of the second inverter.

In an embodiment, the capacitance of the first inverter may be input capacitance of the first inverter, and the capacitance of the second inverter may be input capacitance of the second inverter.

In an embodiment, the first perturbation circuit may include an input node configured to receive a first voltage signal, an output node connected to the input node of the first inverter and configured to output the first perturbation voltage, and a third capacitor connected between an input node and an output node of the first perturbation circuit.

In an embodiment, the second perturbation circuit may include an input node configured to receive a second voltage signal, an output node connected to the input node of the second inverter and configured to output the second perturbation voltage, and a fourth capacitor connected between an input node and an output node of the second perturbation circuit.

In an embodiment, the third capacitor and the fourth capacitor may have the same capacitance.

In an embodiment, the first voltage signal and the second voltage signal may be the same.

In an embodiment, the first voltage signal and the second voltage signal may be the same clock signal.

In an embodiment, the first voltage signal and the second voltage signal may be the same alternating current (AC) signal.

In an embodiment, the first perturbation circuit may further include a fifth switch connected between the third capacitor and the input node of the first inverter, and the second perturbation circuit may further include a sixth switch connected between the fourth capacitor and the input node of the second inverter.

In an embodiment, the fifth switch and the sixth switch may be simultaneously opened or closed.

In an embodiment, the fifth switch and the sixth switch may be configured to be opened or closed simultaneously with the third switch and the fourth switch.

In an embodiment, the circuit may be selectively operable as the random number generator or the PUF device, regardless of a threshold voltage of the first inverter and a threshold voltage of the second inverter.

In an embodiment, the circuit may be selectively operable as the random number generator or the PUF device, regardless of whether a threshold voltage of the first inverter and a threshold voltage of the second inverter coincide with each other.

According to another aspect of the disclosure, a method of operating a circuit selectively operable as a random number generator or a PUF device is provided.

The method may include setting an operating mode of the circuit as the random number generator or the PUF device by operating a third switch connected in parallel with a first capacitor connected between an input node of a first inverter and an output node of a second inverter, and a fourth switch connected in parallel with a second capacitor connected between an output node of the first inverter and an input node of the second inverter, equalizing an input voltage and an output voltage of the first inverter and equalizing an input voltage and an output voltage of the second inverter by simultaneously closing a first switch connected between the input node of the first inverter and the output node of the first inverter, and a second switch connected between the input node of the second inverter and the output node of the second inverter, simultaneously opening the first switch and the second switch, and providing the output voltage of the first inverter as an output of the random number generator or as an output of the PUF device according to an operating mode of the circuit.

In an embodiment, the providing of the output voltage of the first inverter may include, when the operating mode of the circuit is the PUF device, perturbing the input voltage of the first inverter and the input voltage of the second inverter, and providing the stabilized output voltage of the first inverter as the output of the PUF device.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram explaining an inverter and a trip point according to an embodiment;

FIG. 2 is a diagram explaining a latch and a metastable point according to an embodiment;

FIG. 3A is a diagram explaining candidates for a random number generator according to an embodiment;

FIG. 3B is a diagram explaining candidates for a physical unclonable function (PUF) device according to an embodiment;

FIG. 4 is a diagram explaining a circuit according to an embodiment;

FIG. 5 is a flowchart explaining a method of operating a circuit according to an embodiment;

FIG. 6A is a diagram explaining an operation of a circuit as a random number generator according to an embodiment;

FIG. 6B is a diagram explaining an operation of a circuit as a PUF device according to an embodiment;

FIGS. 7A and 7B are diagrams explaining circuits according to embodiments;

FIG. 8 is a flowchart explaining a method of operating a circuit according to an embodiment;

FIG. 9 is a diagram explaining an operation of a circuit as a PUF device according to an embodiment; and

FIG. 10 is a diagram explaining an input/output circuit according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Although terms used herein are of among general terms which are currently and broadly used by considering functions in the disclosure, these terms may vary according to intentions of those of ordinary skill in the art, precedents, the emergence of new technologies, etc. In addition, there may be terms selected arbitrarily by the applicants in particular cases, and in these cases, the meaning of those terms will be described in detail in the corresponding portions of the detailed description. Therefore, the terms used herein should be defined based on the meaning thereof and descriptions made throughout the specification, rather than based on names simply called.

The singular terms used herein are intended to include the plural forms as well, unless the context clearly indicates otherwise. All terms used herein, including technical and scientific terms, have the same meaning as generally understood by those of ordinary skill in the art. Although the terms including an ordinal number such as “first”, “second”, etc. may be used herein to describe various elements or components, these elements or components should not be limited by the terms. The terms are only used to distinguish one element or component from another element or component.

It will be understood that, throughout the specification, when a portion is referred to as “comprising” or “including” a structural element, the portion may further include another structural element in addition to the structural element rather than exclude the other structural element, unless otherwise stated.

In the disclosure, ‘random number generator’ may mean a true random number generator.

In the disclosure, ‘random number’ may mean a true random number.

In the disclosure, ‘connection’ may mean ‘conductive connection’.

Hereinafter, embodiments of the disclosure will be described in detail with reference to the accompanying drawings such that those of ordinary skill in the art may easily implement the embodiments. However, the disclosure may be implemented in different ways and is not limited to the embodiments described herein.

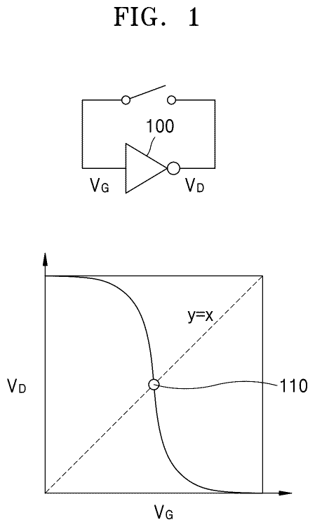

FIG. 1 is a diagram explaining an inverter 100 and a trip point 110 according to an embodiment.

The inverter 100 is a circuit configured to determine an output voltage VD by inverting an input voltage VG. For example, the inverter 100 may be a complementary metal oxide semiconductor (CMOS) inverter. In this case, the input voltage VG of the inverter 100 may be a gate voltage, and the output voltage VD may be a drain voltage.

The trip point 110 of the inverter 100 is a point where the input voltage VG and the output voltage VD are the same in a voltage transfer characteristic curve. The trip point 110 is a threshold voltage of the inverter 100, and an output of the inverter 100 may be switched at the trip point 110. In detail, with respect to the trip point 110, the inverter 100 may convert the low input voltage VG to the high output voltage VD or convert the high input voltage VG to the low output voltage VD.

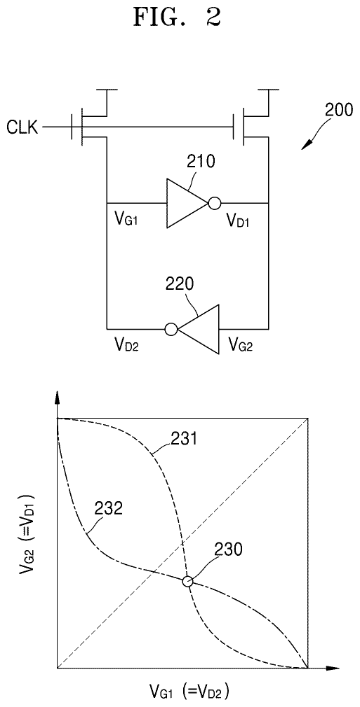

FIG. 2 is a diagram explaining a latch 200 and a metastable point 230 according to an embodiment.

The latch 200 is a circuit configured to set or maintain data according to a clock signal. When a clock is on, a voltage is applied to the latch 200, and thus, logical 0 or 1 may be set. When the clock is off, the voltage is maintained by a first inverter 210 and a second inverter 220, and thus, logical 0 or 1 may be maintained.

The metastable point 230 of the latch 200 is a point where a voltage transfer characteristic curve 231 of the first inverter 210 and a voltage transfer characteristic curve 232 of the second inverter 220 meet. The latch 200 may be switched to an unstable state called the metastable point 230 when the clock signal changes. At the metastable point 230, an output of the latch 200 may be in the unstable state between logical 0 and 1.

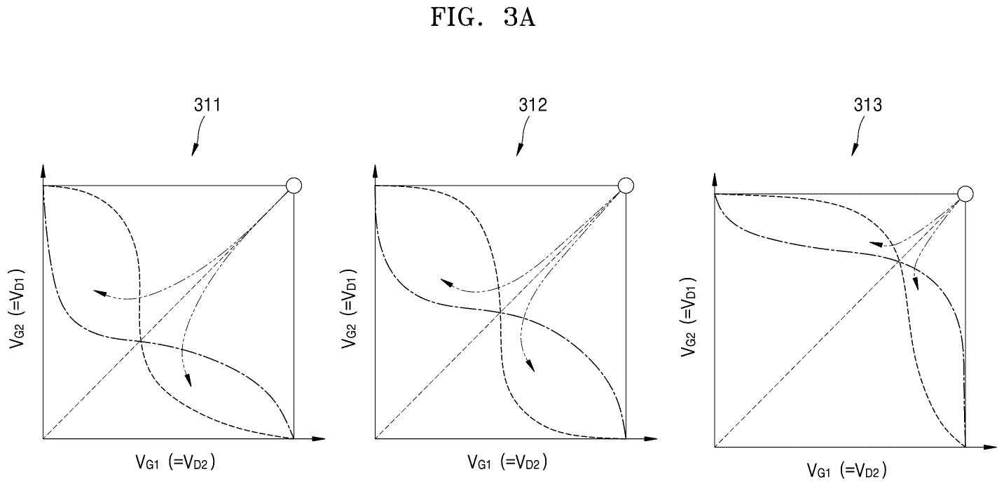

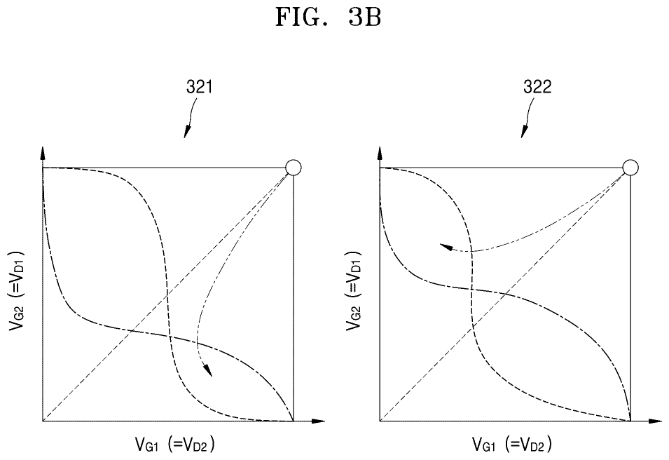

FIG. 3A is a diagram explaining candidates of a random number generator according to an embodiment.

Graphs 311 to 313 of FIG. 3A show voltage transfer characteristic curves of a latch according to embodiments.

In graphs 311 to 313 according to embodiments, metastable points are not biased. That is, metastable points coincide with trip points. In this case, a probability that an output of the latch from the metastable point will be stabilized at logical 0 may be the same as a probability that the output will be stabilized at logical 1. In other words, the output of the latch may be determined randomly. Accordingly, latches having voltage transfer characteristics as the graphs 311 to 313 of FIG. 3A may be used as a random number generator.

FIG. 3B is a diagram explaining candidates of a physical unclonable function (PUF) device according to an embodiment.

Graphs 321 and 322 of FIG. 3B show voltage transfer characteristic curves of a latch according to embodiments.

In the graphs 321 and 322 according to embodiments, metastable points are biased. That is, metastable points do not coincide with trip points. According to an embodiment, in the first graph 321, an output of the latch from the metastable point is stabilized as logical 0. According to an embodiment, in the second graph 322, the output of the latch from the metastable point is stabilized as logical 1. In other words, the output of the latch is uniquely determined. Accordingly, latches having the same voltage transfer characteristics as the graphs 321 and 322 of FIG. 3B may be used as the PUF device.

A trip point and a metastable point are uniquely determined by the physical characteristics of an inverter. Therefore, the voltage transfer characteristics of the latch may be any one of the graphs 311 to 313 and 321 and 322 in FIGS. 3A and 3B, but may not be multiple at the same time. Accordingly, the latch 200 of FIG. 2 may be used as only one of a random number generator and a PUF device.

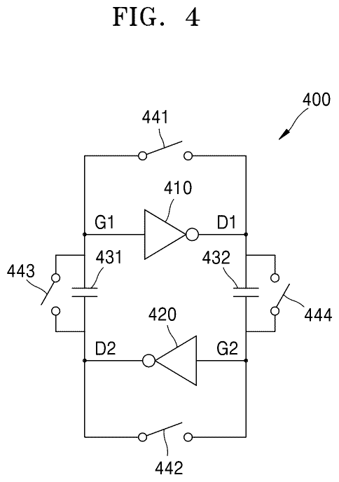

FIG. 4 is a diagram illustrating a circuit 400 according to an embodiment.

The circuit 400 includes a first inverter 410, a second inverter 420, a first capacitor 431, a second capacitor 432, and first to fourth switches 441 to 444.

The first switch 441 is connected between an input node G1 and an output node D1 of the first inverter 410. The second switch 442 is connected between an input node G2 and an output node D2 of the second inverter 420.

The first capacitor 431 is connected between the input node G1 of the first inverter 410 and the output node D2 of the second inverter 420. The second capacitor 432 is connected between the input node G2 of the second inverter 420 and the output node D1 of the first inverter 410.

The third switch 443 is connected in parallel with the first capacitor 431. The fourth switch 444 is connected in parallel with the second capacitor 432.

In an embodiment, the first capacitor 431 and the second capacitor 432 may have the same capacitance.

In an embodiment, the first to fourth switches 441 to 444 may be implemented as transistors. For example, the first to fourth switches 441 to 444 each may be a transmission gate including a p-channel metal-oxide-semiconductor (PMOS) transistor and an n-channel metal-oxide semiconductor (NMOS) transistor, a switch including a PMOS transistor, or a switch including an NMOS transistor, but is not limited thereto.

In an embodiment, the first switch 441 and the second switch 442 may be opened or closed simultaneously. For example, the first switch 441 and the second switch 442 may be opened and closed simultaneously based on the same clock signal.

In an embodiment, the third switch 443 and the fourth switch 444 may be opened or closed simultaneously. For example, the third switch 443 and the fourth switch 444 may be opened and closed simultaneously based on the same clock signal.

As described above, the circuit 400 is based on a latch structure, and may have high energy efficiency and a small area.

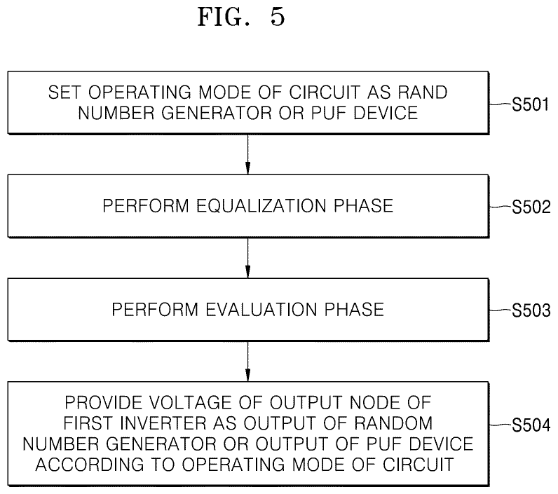

The circuit 400 may selectively operate as a random number generator or a PUF device according to the opening and closing of the third switch 443 and the fourth switch 444. When the third switch 443 and the fourth switch 444 are opened, the circuit 400 may operate as a random number generator. Alternatively, the circuit 400 may operate as a PUF device when the third switch 443 and the fourth switch 444 are closed. A detailed operation of the circuit 400 will be described with reference to FIG. 5.

FIG. 5 is a flowchart explaining a method of operating the circuit 400 according to an embodiment.

Referring to FIGS. 4 and 5, in operation S501, an operating mode of the circuit 400 is set as a random number generator or a PUF device.

The operating mode of the circuit 400 may be set to the random number generator by opening the third switch 443 and the fourth switch 444. Alternatively, the operating mode of the circuit 400 may be set to the PUF device by closing the third switch 443 and the fourth switch 444.

In operation S502, an equalization phase is performed.

The equalization phase may start by simultaneously closing the first switch 411 and the second switch 412. As the first switch 411 is closed, voltages of the input node G1 and the output node D1 of the first inverter 410 may be equalized. In addition, as the second switch 412 is closed, voltages of the input node G2 and the output node D2 of the second inverter 420 may be equalized.

When the operating mode of the circuit 400 is the random number generator, because the third switch 443 is opened, a voltage difference between the input node G1 of the first inverter 410 and the output node D2 of the second inverter 420 may be allowed by the first capacitor 431. In addition, because the fourth switch 444 is opened, a voltage difference between the input node G2 of the second inverter 420 and the output node D1 of the first inverter 410 may be allowed by the second capacitor 432. Accordingly, regardless of a threshold voltage of the first inverter 410 and a threshold voltage of the second inverter 420, the voltages of the input node G1 and the output node D1 of the first inverter 410 may be equalized to the threshold voltage of the first inverter 410, and the voltages of the input node G2 and the output node D2 of the second inverter 420 may be equalized to the threshold voltage of the second inverter 420.

When the operating mode of the circuit 400 is the PUF device, because the third switch 443 is closed, the voltage difference between the input node G1 of the first inverter 410 and the output node D2 of the second inverter 420 may not be allowed. In addition, because the fourth switch 444 is closed, the voltage difference between the input node G2 of the second inverter 420 and the output node D1 of the first inverter 410 may not be allowed. Accordingly, the voltages of the input node G1 and the output node D1 of the first inverter 410 and the input node G2 and the output node D2 of the second inverter 420 may all be equalized to the same value.

In operation S503, an evaluation phase is performed.

By opening the first switch 441 and the second switch 442 simultaneously, the equalization phase may end and the evaluation phase may start. The first switch 441 and the second switch 442 may be opened until the next equalization phase starts.

When the operating mode of the circuit 400 is the random number generator, because the voltages of the input node G1 and the output node D1 of the first inverter 410 are equalized to the threshold voltage of the first inverter 410 in the equalization phase, the voltage of the output node D1 of the first inverter 410 may be determined randomly. In addition, because the voltages of the input node G2 and the output node D2 of the second inverter 420 are equalized to the threshold voltage of the second inverter 420 in the equalization phase, the voltage of the output node D2 of the second inverter 420 may be determined randomly. That is, regardless of the threshold voltage of the first inverter 410 and the threshold voltage of the second inverter 420, the circuit 400 may operate as the random number generator.

When the operating mode of the circuit 400 is the PUF device, in the equalization phase, the voltages of the input node G1 and the output node D1 of the first inverter 410 and the input node G2 and the output node D2 of the second inverter 420 are all equalized to the same value. When a metastable point of the first inverter 410 and the second inverter 420 is biased, based on the unique physical characteristics of the first inverter 410 and the second inverter 420, the voltage of the output node D1 of the first inverter 410 and the voltage of the output node D2 of the second inverter 420 may be uniquely determined.

In operation S504, according to the operating mode of the circuit 400, the voltage of the output node D1 of the first inverter 410 is provided as an output of the random number generator or an output of the PUF device.

An output logical of the circuit 400 may be determined according to the voltage of the output node D1 of the first inverter 410 stabilized in the evaluation phase. A high output voltage of the first inverter 410 may determine the output of the circuit 400 to be logical 1, and a low output voltage of the first inverter 410 may determine the output of the circuit 400 to be logical 0. In another embodiment, the output logical of the circuit 400 may be determined according to the voltage of the output node D2 of the stabilized second inverter 420.

When the operating mode of the circuit 400 is the random number generator, the voltage of the output node D1 of the first inverter 410 is randomly determined in the evaluation phase. Accordingly, the circuit 400 may provide random logical 0 or 1 as the output of the random number generator.

When the operating mode of the circuit 400 is the PUF device, the voltage of the output node D1 of the first inverter 410 is uniquely determined in the evaluation phase. Accordingly, the circuit 400 may provide unique logical 0 or 1 as the output of the PUF device.

As explained above, the operation of the circuit 400 does not require calibration process. In addition, because the equalization phase and the evaluation phase may be performed at high speed, the circuit 400 may operate at high speed.

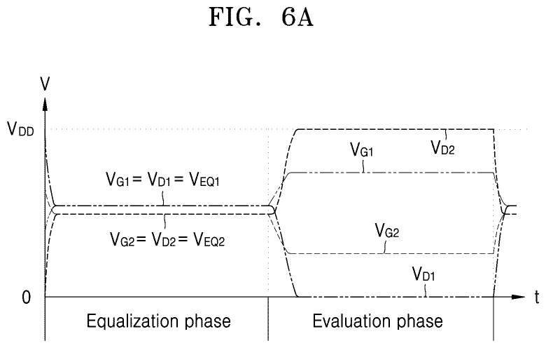

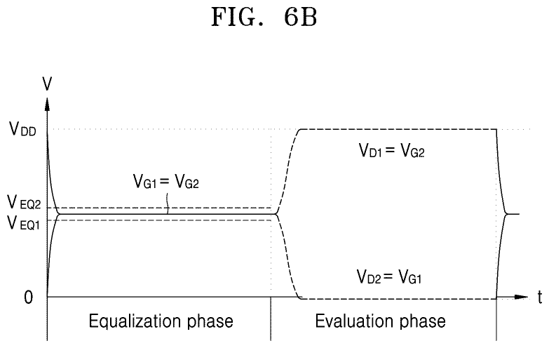

FIG. 6A is a diagram explaining the operation of the circuit 400 as a random number generator according to an embodiment.

FIG. 6A shows a graph of input voltages V_{G1} and V_{G2} and output voltages V_{D1} and V_{D2} of the first inverter 410 and the second inverter 420 when the circuit 400 of FIG. 4 operates as the random number generator.

Referring to FIGS. 4 and 6A, in the equalization phase, the input voltage V_{G1} and the output voltage V_{D1} of the first inverter 410 may be equalized to a first threshold voltage V_{EQ1} of the first inverter 410, and the input voltage V_{G2} and the output voltage V_{D2} of the second inverter 420 may be equalized to a second threshold voltage V_{EQ2} of the second inverter 420. A voltage difference may be allowed between the input node G1 of the first inverter 410 and the output node D2 of the second inverter 420 by the first capacitor 431, and a voltage difference between the input node G2 of the second inverter 420 and the output node D1 of the first inverter 410 may be allowed by the second capacitor 432, and thus, the first inverter 410 may be equalized to the first threshold voltage V_{EQ1}, and the second inverter 420 may be equalized to the second threshold voltage V_{EQ2}.

Because the input voltage V_{G1} and the output voltage V_{D1} of the first inverter 410 are the same as the first threshold voltage V_{EQ1}, the output voltage V_{D1} of the first inverter 410 may be randomly determined in the evaluation phase. In addition, because the input voltage V_{G2} and the output voltage V_{D2} of the second inverter 420 are the same as the second threshold voltage V_{EQ2}, the output voltage V_{D2} of the second inverter 420 may be randomly determined in the evaluation phase.

FIG. 6A shows a graph in which the output voltage V_{D1} of the first inverter 410 is randomly determined to be 0 and the output voltage V_{D2} of the second inverter 420 is randomly determined to be V_{DD}. However, in another embodiment, the output voltage V_{D1} of the first inverter 410 may be randomly determined to be V_{DD}, and the output voltage V_{D2} of the second inverter 420 may be randomly determined to be 0.

FIG. 6B is a diagram explaining an operation of the circuit 400 as a PUF device according to an embodiment.

FIG. 6B shows a graph of the input voltages V_{G1} and V_{G2} and the output voltages V_{D1} and V_{D2} of the first inverter 410 and the second inverter 420 when the circuit 400 of FIG. 4 operates as a PUF device.

Referring to FIGS. 4 and 6B, in the equalization phase, the input voltage V_{G1} and the output voltage V_{D1} of the first inverter 410 and the input voltage V_{G2} and the output voltage V_{D2} of the second inverter 420 are all may be equalized to the same value. When a metastable point of the first inverter 410 and the second inverter 420 is biased, the equalized input voltage V_{G1} and output voltage V_{D1} of the first inverter 410 may be different from the first threshold voltage V_{EQ1}, the equalized input voltage V_{G2} and output voltage V_{D2} of the second inverter 420 may be different from the second threshold voltage V_{EQ2}.

A difference between the input voltage V_{G1} of the first inverter 410 and the first threshold voltage V_{EQ1} may uniquely determine the output voltage V_{D1} of the first inverter 410 in the evaluation phase. Likewise, a difference between the input voltage V_{G2} of the second inverter 420 and the second threshold voltage V_{EQ2} may uniquely determine the output voltage V_{D2} of the second inverter 420 in the evaluation phase.

FIG. 6B shows a graph in which the output voltage V_{D1} of the first inverter 410 is determined to be V_{DD}, and the output voltage V_{D2} of the second inverter 420 is determined to be 0. Because the first threshold voltage V_{EQ1} and the second threshold voltage V_{EQ2} are unique characteristics of the first inverter 410 and the second inverter 420, respectively, for the same input, the output voltage V_{D1} of the first inverter 410 may be uniquely determined to be V_{DD}, and the output voltage V_{D2} of the second inverter 420 may be uniquely determined to be 0.

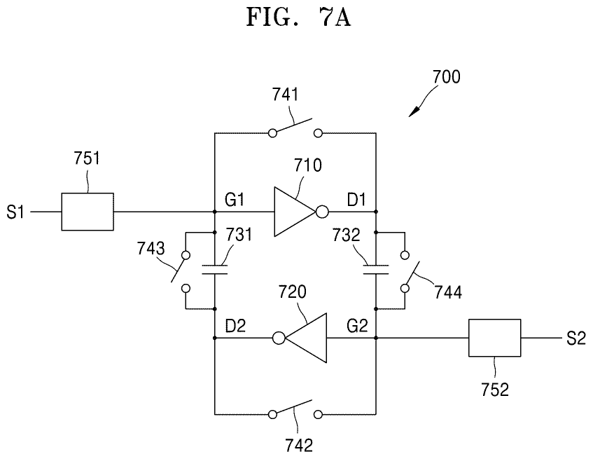

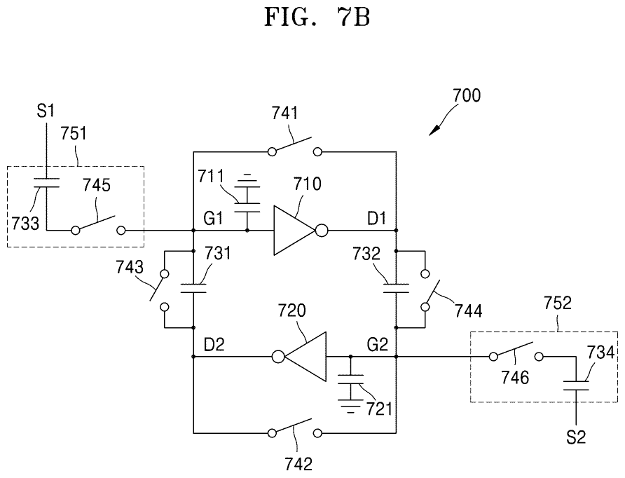

FIG. 7A is a diagram explaining a circuit 700 according to an embodiment.

Descriptions according to the embodiments may be applied to the circuit 700. Redundant descriptions are omitted.

The circuit 700 includes a first inverter 710, a second inverter 720, a first capacitor 731, a second capacitor 732, first to fourth switches 741 to 744, a first perturbation circuit 751, and a second perturbation circuit 752.

Regardless of whether threshold voltages of the first inverter 710 and the second inverter 720 coincide with each other, the circuit 700 may operate as a random number generator. This is because, in the equalization phase, input/output voltages of the first inverter 710 are equalized to a threshold voltage of the first inverter 710, and independently of this, input/output voltages of the second inverter 720 are equalized to a threshold voltage of the second inverter 720. Because the output voltage of each of the first inverter 710 and the second inverter 720 is randomly determined at a trip point, the circuit 700 may operate as the random number generator.

When the threshold voltages of the first inverter 710 and the second inverter 720 do not coincide with each other, the circuit 700 may operate as a PUF device. That is, when the metastable point of the first inverter 710 and the second inverter 720 is biased, the circuit 700 may operate as the PUF device. Because the biased metastable point generates unique output voltages based on the physical characteristics of the first inverter 710 and the second inverter 720, the circuit 700 may operate as the PUF device.

The circuit 700 may include a first perturbation circuit 751 and a second perturbation circuit 752 configured to apply perturbation voltages to the first inverter 710 and the second inverter 720. An input node of the first perturbation circuit 751 may receive a first voltage signal S1, and an output node of the first perturbation circuit 751 may provide a first perturbation voltage to an input node G1 of the first inverter 710. An input node of the second perturbation circuit 752 may receive a second voltage signal S2, and an output node of the second perturbation circuit 752 may provide a second perturbation voltage to an input node G2 of the second inverter 720.

The first perturbation voltage of the first perturbation circuit 751 may be determined based on the capacitance of the first inverter 710. That is, the first perturbation voltage of the first perturbation circuit 751 may be determined according to a value of the capacitance of the first inverter 710. The second perturbation voltage of the second perturbation circuit 752 may be determined based on the capacitance of the second inverter 720. That is, the second perturbation voltage of the second perturbation circuit 752 may be determined according to a value of the capacitance of the second inverter 720.

In an embodiment, the capacitances of the first inverter 710 and the second inverter 720 may mean parasitic capacitances of the first inverter 710 and the second inverter 720, respectively. In an embodiment, the capacitances of the first inverter 710 and the second inverter 720 may mean input capacitances of the first inverter 710 and the second inverter 720, respectively.

The capacitance of the first inverter 710 and the capacitance of the second inverter 720 are determined by the unique physical characteristics of the first inverter 710 and the second inverter 720, respectively, and thus, may be different from each other. Accordingly, there may be a difference between the first perturbation voltage determined based on the capacitance of the first inverter 710 and the second perturbation voltage determined based on the capacitance of the second inverter 720.

The first voltage signal S1 and the second voltage signal S2 may be the same. For example, the first voltage signal S1 and the second voltage signal S2 may be signals supplied from the same signal source. Because the first voltage signal S1 and the second voltage signal S2 are the same, a difference between the first perturbation voltage and the second perturbation voltage may be determined only based on the capacitances of the first inverter 710 and the second inverter 720.

In an embodiment, the first voltage signal S1 and the second voltage signal S2 may be the same clock signal. In an embodiment, the first voltage signal S1 and the second voltage signal S2 may be the same alternating current (AC) signals. Because the first voltage signal S1 and the second voltage signal S2 are AC signals, the first perturbation voltage and the second perturbation voltage may be determined based on the capacitances of the first inverter 710 and the second inverter 720, respectively.

The first perturbation voltage and the second perturbation voltage may be determined based on the capacitances of the first inverter 710 and the second inverter 720, that is, the unique physical characteristics of the first inverter 710 and the second inverter 720, respectively. Therefore, when threshold voltages of the first inverter 710 and the second inverter 720 coincide with each other, a bias based on the unique physical characteristics of the first inverter 710 and the second inverter 720 is added by the first perturbation voltage and the second perturbation voltage, and thus, the circuit 700 may operate as a PUF device.

Accordingly, regardless of the threshold voltages of the first inverter 710 and the second inverter 720, the circuit 700 may operate as the PUF device.

The first perturbation circuit 751 and the second perturbation circuit 752 may be implemented in various ways to generate the first perturbation voltage and the second perturbation voltage determined based on the capacitances of the first inverter 710 and the second inverter 720, respectively. Referring to FIG. 7B, an example of implementation of the first perturbation circuit 751 and the second perturbation circuit 752 will be described.

FIG. 7B is a diagram explaining the circuit 700 according to an embodiment.

In an embodiment, the first perturbation circuit 751 may include a fifth switch 745 and a third capacitor 733, and the second perturbation circuit 752 may include a sixth switch 746 and a fourth capacitor 734.

The third capacitor 733 is connected between an input node of the first perturbation circuit 751 and the input node G1 of the first inverter 710. The fourth capacitor 734 is connected between an input node of the second perturbation circuit 752 and the input node G2 of the second inverter 720.

The fifth switch 745 may control the transmission of a first perturbation signal. The sixth switch 746 may control transmission of a second perturbation signal. In an embodiment, the fifth switch 745 may be connected between the third capacitor 733 and the input node G1 of the first inverter 710. The sixth switch 746 may be connected between the fourth capacitor 734 and the input node G2 of the second inverter 720.

The first perturbation voltage of the first perturbation circuit 751 may be determined based on the capacitance of an input capacitor 711 of the first inverter 710. The second perturbation voltage of the second perturbation circuit 752 may be determined based on the capacitance of an input capacitor 721 of the second inverter 720. For example, when the first inverter 710 and the second inverter 720 are CMOS inverters, the first input capacitor 711 may be a gate capacitor of the first CMOS inverter 710, and the second input capacitor 721 may be a gate capacitor of the second CMOS inverter 720.

The capacitance of the first input capacitor 711 and the capacitance of the second input capacitor 712 may be different from each other. Accordingly, there may be a difference between the first perturbation voltage determined based on the capacitance of the first input capacitor 711 and the second perturbation voltage determined based on the capacitance of the second input capacitor 721.

For example, when the first inverter 710 and the second inverter 720 are CMOS inverters, the capacitance of the first input capacitor 711 may be determined based on the product between a length and a width of the first CMOS inverter 710, and the capacitance of the second input capacitor 721 may be determined based on the product between a length and a width of the second CMOS inverter 720. When the product between the length and the width of the first CMOS inverter 710 is different from the product between the length and the width of the second CMOS inverter 720, the capacitance of the first input capacitor 711 and the capacitance of the second input capacitor 721 may be different from each other.

The capacitance of the third capacitor 733 and the capacitance of the fourth capacitor 734 may be the same. Because the first voltage signal S1 and the second voltage signal S2 are the same, and capacitance of the third capacitor 733 and the capacitance of the fourth capacitor 734 are the same, a difference between the first perturbation and the second perturbation may be determined based on only the capacitances of the first input capacitor 711 and the second input capacitor 721.

In an embodiment, the fifth switch 745 and the sixth switch 746 may be opened or closed simultaneously. For example, the fifth switch 745 and the sixth switch 746 may be opened and closed simultaneously based on the same clock signal. The fifth switch 745 and the sixth switch 746 may be opened when an operating mode of the circuit 700 is a random number generator, and may be closed when the operating mode of the circuit 700 is a PUF device.

In an embodiment, the fifth switch 745 and the sixth switch 746 may be opened or closed simultaneously with a third switch 743 and a fourth switch 744. For example, the third to sixth switches 743 to 746 may be opened and closed simultaneously based on the same clock signal.

As described above, the circuit 700 of FIGS. 7A and 7B is based on a latch structure, and thus, the circuit 700 may have high energy efficiency and a small area.

The circuit 700 of FIGS. 7A and 7B may selectively operate as the random number generator or the PUF device. In an embodiment, the circuit 700 may operate as the random number generator when the third to sixth switches 743 to 746 are opened and as the PUF device when the third to sixth switches 743 to 746 are closed.

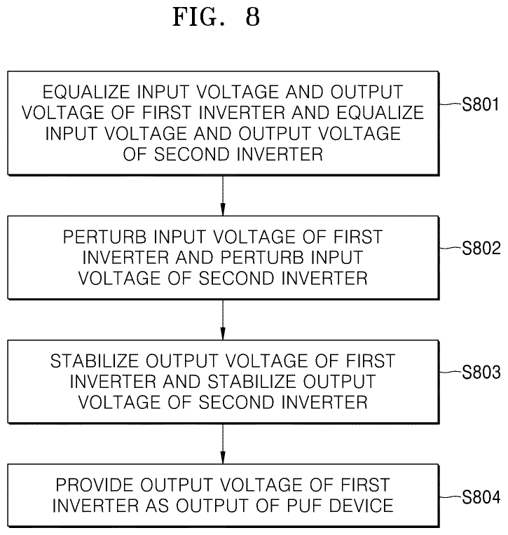

The description of the embodiments with reference to FIGS. 4, 5, and 6A may be applied to a method of operating the circuit 700 as the random number generator. A detailed operation of the circuit 700 when the operating mode is the PUF device is described with reference to FIG. 8.

FIG. 8 is a flowchart explaining a method of operating the circuit 700 according to an embodiment.

An operating mode of the circuit 700 may be set to a PUF device by closing the third to sixth switches 743 to 746.

Referring to FIGS. 7A, 7B, and 8, in operation S801, an input voltage and an output voltage of the first inverter 710 are equalized, and an input voltage and an output voltage of the second inverter 720 are equalized.

An equalization phase may start by simultaneously closing the first switch 711 and the second switch 712. Because the third switch 743 and the fourth switch 744 are closed, in the equalization phase, voltages of the input node G1 and the output node D1 of the first inverter 710 and the input node G2 and the output node D2 of the second inverter 720 may all be equalized to the same value.

In operation S802, the input voltage of the first inverter 710 is perturbed and the input voltage of the second inverter 720 is perturbed.

The equalization phase may end and an evaluation phase may start by opening the first switch 741 and the second switch 742 simultaneously. In the evaluation phase, the voltage of the input node G1 of the first inverter 710 may be perturbed by a first perturbation voltage of the first perturbation circuit 751. In addition, the voltage of the input node G2 of the second inverter 720 may be perturbed by a second perturbation voltage of the second perturbation circuit 752.

As the capacitances of the first input capacitor 711 and the second input capacitor 712 are different from each other, the magnitudes of the first perturbation voltage and the second perturbation voltage may be different from each other. Accordingly, the degree to which the voltage of the input node G1 of the first inverter 710 is perturbed by the first perturbation voltage and the voltage of the input node G2 of the second inverter 720 is perturbed by the second perturbation voltage may be different from each other.

In operation S803, the output voltage of the first inverter 710 is stabilized, and the output voltage of the second inverter 720 is stabilized.

As the evaluation phase continues, the output voltage of the first inverter 710 and the output voltage of the second inverter 720 may be stabilized.

In an embodiment, when threshold voltages of the first inverter 710 and the second inverter 720 are different from each other, the voltage of the output node D1 of the first inverter 710 and the voltage of the output node D2 of the second inverter 720 may be uniquely determined.

In an embodiment, when the threshold voltages of the first inverter 710 and the second inverter 720 are the same, the output voltages of the first inverter 710 and the second inverter 720 may escape from trip points by the first perturbation voltage and the second perturbation voltage. Because the first perturbation voltage and the second perturbation voltage are based on the unique physical characteristics of the first inverter 710 and the second inverter 720, the voltage of the output node D1 of the first inverter 710 and the voltage of the output node D2 of the second inverter 720 may be uniquely determined based on the first perturbation voltage and the second perturbation voltage.

In operation S804, the output voltage of the first inverter 710 is provided as the output of the PUF device.

According to a voltage of the stabilized output node D1 of the first inverter 710, an output logical of the circuit 700 may be determined. A high output voltage of the first inverter 710 may determine the output of the circuit 700 to be logical 1, and a low output voltage of the first inverter 710 may determine the output of the circuit 700 to be logical 0.

In the evaluation phase, the voltage of the output node D1 of the first inverter 710 is determined based on the unique physical characteristics of the first inverter 710 and the second inverter 720. Accordingly, the circuit 700 may provide the uniquely determined logical 0 or 1 as the output of the PUF device.

As described above, the operation of circuit 700 does not require calibration process. In addition, because the equalization phase and the evaluation phase may be performed at high speed, the circuit 700 may operate at high speed.

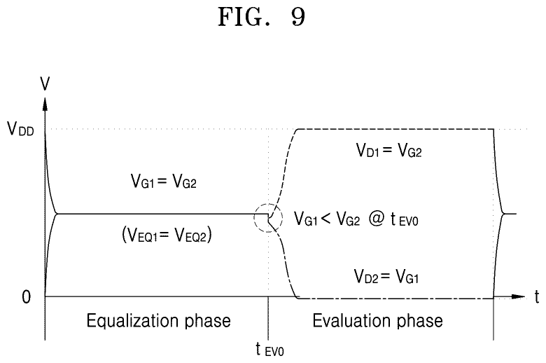

FIG. 9 is a diagram explaining an operation of the circuit 700 as a PUF device according to an embodiment.

FIG. 9 shows a graph of the input voltages V_{G1} and V_{G2} and the output voltages V_{D1} and V_{D2} of the first inverter 710 and the second inverter 720 when the circuit 700 of FIGS. 7A and 7B operates as the PUF device.

Referring to FIGS. 7A, 7B, and 9, in an equalization phase, the input voltage V_{G1} and the output voltage V_{D1} of the first inverter 710 and the input voltage V_{G2} and the output voltage V_{D2} of the second inverter 720 are all may be equalized to the same value. In an embodiment, as metastable point of the first inverter 710 and the second inverter 720 is not biased, the input voltage V_{G1} and the output voltage V_{D1} of the first inverter 710 and the input voltage V_{G2} and the output voltage V_{D2} of the second inverter 720 may be equalized to the first threshold voltage V_{EQ1} (=the second threshold voltage V_{EQ2}).

As the first switch 741 and the second switch 742 are opened at t_{EV0}, the evaluation phase may start.

Because a first perturbation voltage and a second perturbation voltage are determined based on the unique physical characteristics of the first inverter 710 and the second inverter 720, respectively, there may be a difference between the first perturbation voltage and the second perturbation voltage. The difference between the first perturbation voltage and a second perturbation voltage results in a difference between the input voltage V_{G1} of the first inverter 710 and the input voltage V_{G2} of the second inverter 720 (or the output voltage V_{D1} of the first inverter 710 and the output voltage V_{D2} of the second inverter 720) at t_{EV0}.

In an embodiment, as the first perturbation voltage is greater than the second perturbation voltage, the input voltage V_{G1} of the first inverter 710 may be less than the input voltage V_{G2} of the second inverter 720 at t_{EV0}. For example, when the product between a length and a width of the first CMOS inverter 710 is less than the product between a length and a width of the second CMOS inverter 720, the capacitance of the first input capacitor 711 may be smaller than the capacitance of the second input capacitor 712, accordingly, the first perturbation voltage at t_{EV0} may be greater than the second perturbation voltage.

In an embodiment, as the input voltage V_{G1} of the first inverter 710 is less than the input voltage V_{G2} of the second inverter 720 at t_{EV0}, the output voltage V_{D1} of the first inverter 710 may be determined to be V_{DD}, the output voltage V_{D2} of the second inverter 720 may be determined to be 0. Because the first perturbation voltage and the second perturbation voltage are due to the unique physical characteristics of the first inverter 710 and the second inverter 720, respectively, with respect to the same input, the output voltage V_{D1} of the first inverter 710 may be uniquely determined to be V_{DD}, the output voltage V_{D2} of the second inverter 720 may be uniquely determined to be 0.

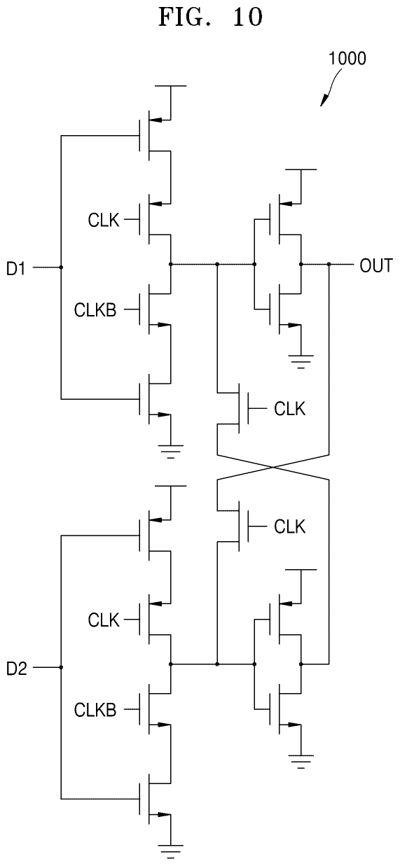

FIG. 10 is a diagram illustrating an input/output circuit 1000 according to an embodiment.

The input/output circuit 1000 may be connected to the circuits 400 and 700 according to embodiments and provide an output as a random number generator or PUF device to the outside.

In an embodiment, the input/output circuit 1000 may be configured to not output a voltage of the output node D1 of a first inverter in an equalization phase, but to output a voltage of the output node D1 of the first inverter equalized in an evaluation phase. Unlike this, the input/output circuit 1000 may be configured to output a voltage of the output node D2 of a second inverter.

From an output node OUT of the input/output circuit 1000, random logical 0 or 1 may be provided as an output of a random number generator. In addition, from the output node OUT of the input/output circuit 1000, unique logical 0 or 1 may be provided as an output of a PUF device.

The embodiments of the disclosure provide a circuit that may be selectively used as a random number generator or a PUF device.

In the embodiments of the disclosure, an operation of the circuit does not require calibration process.

In the embodiments of the disclosure, the circuitry may operate at high speed.

In the embodiments of the disclosure, the circuit is based on a latch structure, and thus, the circuit may have high energy efficiency and a small area.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A circuit selectively operable as a random number generator or a physical unclonable function (PUF) device, the circuit comprising:
a first inverter;
a second inverter;
a first switch connected between an input node of the first inverter and an output node of the first inverter;
a second switch connected between an input node of the second inverter and an output node of the second inverter;
a first capacitor connected between the input node of the first inverter and the output node of the second inverter;
a second capacitor connected between the output node of the first inverter and the input node of the second inverter;
a third switch connected in parallel with the first capacitor; and
a fourth switch connected in parallel with the second capacitor.

2. The circuit of claim 1, wherein the circuit is operable as the random number generator when the third switch and the fourth switch are opened.

3. The circuit of claim 1, wherein the circuit is operable as the PUF device when the third switch and the fourth switch are closed.

4. The circuit of claim 1, wherein the third switch and the fourth switch are simultaneously opened or closed.

5. The circuit of claim 1, further comprising:
a first perturbation circuit configured to apply a first perturbation voltage to the input node of the first inverter; and
a second perturbation circuit configured to apply a second perturbation voltage to the input node of the second inverter.

6. The circuit of claim 5, wherein
the first inverter and the second inverter are complementary metal oxide semiconductor (CMOS) inverters,
the first perturbation voltage is determined based on a product between a length and a width of the first inverter, and
the second perturbation voltage is determined based on a product between a length and a width of the second inverter.

7. The circuit of claim 5, wherein
the first perturbation voltage is determined based on capacitance of the first inverter, and
the second perturbation voltage is determined based on capacitance of the second inverter.

8. The circuit of claim 7, wherein
the capacitance of the first inverter is input capacitance of the first inverter, and
the capacitance of the second inverter is input capacitance of the second inverter.

9. The circuit of claim 5, wherein the first perturbation circuit includes
an input node configured to receive a first voltage signal;
an output node connected to the input node of the first inverter and configured to output the first perturbation voltage; and
a third capacitor connected between an input node and an output node of the first perturbation circuit.

10. The circuit of claim 9, wherein the second perturbation circuit includes
an input node configured to receive a second voltage signal;
an output node connected to the input node of the second inverter and configured to output the second perturbation voltage; and
a fourth capacitor connected between an input node and an output node of the second perturbation circuit.

11. The circuit of claim 10, wherein the third capacitor and the fourth capacitor have same capacitance.

12. The circuit of claim 10, wherein the first voltage signal and the second voltage signal are same.

13. The circuit of claim 10, wherein the first voltage signal and the second voltage signal are a same clock signal.

14. The circuit of claim 10, wherein the first voltage signal and the second voltage signal are a same alternating current (AC) signal.

15. The circuit of claim 10, wherein
the first perturbation circuit further includes a fifth switch connected between the third capacitor and the input node of the first inverter, and
the second perturbation circuit further includes a sixth switch connected between the fourth capacitor and the input node of the second inverter.

16. The circuit of claim 15, wherein the fifth switch and the sixth switch are simultaneously opened or closed.

17. The circuit of claim 15, wherein the fifth switch and the sixth switch are configured to be opened or closed simultaneously with the third switch and the fourth switch.

18. The circuit of claim 1, wherein the circuit is selectively operable as the random number generator or the PUF device regardless of a threshold voltage of the first inverter and a threshold voltage of the second inverter.

19. The circuit of claim 1, wherein the circuit is selectively operable as the random number generator or the PUF device regardless of whether a threshold voltage of the first inverter and a threshold voltage of the second inverter coincide with each other.

20. A method of operating a circuit selectively operable as a random number generator or a physical unclonable function (PUF) device, the method comprising:
setting an operating mode of the circuit as the random number generator or the PUF device by operating a third switch connected in parallel with a first capacitor connected between an input node of a first inverter and an output node of a second inverter, and a fourth switch connected in parallel with a second capacitor connected between an output node of the first inverter and an input node of the second inverter;
equalizing an input voltage and an output voltage of the first inverter and equalizing an input voltage and an output voltage of the second inverter by simultaneously closing a first switch connected between the input node of the first inverter and the output node of the first inverter, and a second switch connected between the input node of the second inverter and the output node of the second inverter;
simultaneously opening the first switch and the second switch; and
providing the output voltage of the first inverter as an output of the random number generator or as an output of the PUF device according to an operating mode of the circuit.

21. The method of claim 20, wherein the providing of the output voltage of the first inverter includes,
when the operating mode of the circuit is the PUF device,
perturbing the input voltage of the first inverter and the input voltage of the second inverter; and
providing a stabilized output voltage of the first inverter as the output of the PUF device.
